(19) United States
(12) Patent Application Publication
(10) Pub. No.: US 2002/0108469 A1
(43) Pub. Date: Aug. 15, 2002

(54) POROUS AGGLOMERATES AND PROCESS FOR THEIR PRODUCTION

(76) Inventor: DIETER BEHRENS, BAD HARZBURG (DE)

Correspondence Address: Patent Department, BAYER CORPORATION, 100 Bayer Road, Pittsburgh, PA, 15201-9741, US

(21) Appl. No.: 09/250,987

(22) Filed: Feb. 16, 1999

(30) Foreign Application Priority Data
Feb. 17, 1998 (DE) 19806470.5
Dec. 4, 1998 (DE) 19855998.4

(51) Int. Cl. C04B 38/02

(52) U.S. Cl. 75/770; 501/84

(57) ABSTRACT

Slurries of metallic or ceramic powders are prepared in water which contains gas-eliminating substances such as carbonic acid, hydrogen peroxide, carbonates or hydrogen carbonates. This results in highly porous, solid cakes which may be processed by breaking and/or grinding to yield granules having a low fines content. Depending upon the intended application, the adhesively bound agglomerates may very readily be suspended, used as sintering precursors or as starting substances for solid-state reactions.

Many industrial processes in which powders are used require agglomeration of the powders.

In the simplest case, agglomeration is intended to prevent dusting during handling of the powders. When the powders are further processed, the agglomerates must then be broken back down, for example in order to prepare a suspension of the powders. An elevated porosity of the powders facilitates preparation of a suspension.

When performing solid-state reactions with liberation of gas or reactions between solids and liquids or gases, an elevated porosity promotes the reactivity of the agglomerates.

In the case of solid catalysts, a large specific surface area is required, which is achieved by sintering fine-grained powders. Agglomerates having an elevated porosity are advantageously used for sintering.

Another sector which requires sintered articles of elevated porosity is the passive electronic components sector. For example, the electrolytic capacitor plate of capacitors having an elevated specific capacitance consists of a porous metallic sintered article, onto which an insulating layer is applied by anodisation, wherein the other capacitor plate is constituted by an electrolyte, into which the passivated metal electrode is introduced.

There is thus a desire in many industrial sectors for porous agglomerates of metallic or ceramic powders as precursors for the further processing thereof.

It is known to prepare a slurry of powders in water, optionally with addition of wetting agents, and then to produce a solid cake by removing the water, which cake is broken or ground to yield granules of a suitable size and shape. Depending upon the shape and size distribution of the primary powder particles, such cakes have densities amounting to 40 to 60% of the powder material itself. Such densities, which may be even higher in the case of an elevated fines content, are undesirably high for many applications. Cakes of this density have high strength, such that comparatively large forces must be applied during grinding. Additional compaction of the ground material must be expected in this case. This inevitably results in highly uneven granules with an elevated fines content. In many applications, the fines content must be screened out and, in this form, is unavailable for further processing.

It has now been found that adhesively bound, highly porous agglomerates having densities of only 10 to 30%, preferably 10 to 20%, of the powder material itself may be produced if the agglomerating agent used is a liquid which liberates or splits off gases on drying. Such porous agglomerates may be processed with application of only slight force to yield granules which have only very low contents of fine particles.

Suitable agglomerating agents are in particular water containing hydrogen peroxide, carbon dioxide, ammonium hydrogen carbonate or ammonium carbonate as the gas-liberating compound. Preferred gas-eliminating compounds are in particular hydrogen peroxide and carbon dioxide.

The agglomerates according to the invention contain no binder whatsoever. The powders are bound together solely by adhesive forces which may develop by the electrostatic repulsive forces between the powder particles being cancelled out in the aqueous suspension, such that the particles may come into direct contact, wherein, with the assistance of the polar water molecule, surface charges or polarities are reversed and not re-established during or after vaporisation of the water.

The invention is based on the recognition that, providing that the cake is still sufficiently moist when the gas is liberated, the moisture constitutes a seal which prevents liberated gas from escaping from the cake. Solidification does not occur until the drying process is concluded to such an extent that additionally liberated gas may escape via the open pores which are then already present. The solidification process thus occurs so late that it is not prevented or disrupted by further foaming of the cake. The cake is comminuted by breaking the adhesive bridges between the pores and results in only very slight formation of fines.

The present invention accordingly provides adhesively bound agglomerates of metallic or ceramic powders characterised by a pore volume of 80 to 90%.

The present invention also provides a process for the production of porous agglomerates of metallic or ceramic powders, wherein a slurry of the powders is prepared in water, the slurry is dried to form a cohesive cake and the dry cake is comminuted by grinding or breaking to yield pourable agglomerates, which process is characterised in that the slurry is prepared using water in which substances are dissolved which, on drying, decompose to split off gases, or release gases during drying.

The type and quantity of the gas-liberating compound or the dissolved gas are selected depending upon the desired pore volume and the compatibility of the gas-liberating products with the powder material.

The present invention also provides the process for the production of suspensions or slurries of ceramic powders, which process is characterised in that highly porous agglomerates according to the invention are granulated in the suspending medium or slurry formulation and the granulates are broken under the action of shearing forces, for example stirring.

The present invention furthermore provides a process for the production of porous sintered articles, which process is characterised in that, optionally after granulation, highly porous agglomerates according to the invention are subjected to treatment at sintering temperatures, optionally under a protective gas or vacuum. It has been found that the agglomerates and granules according to the invention have particularly elevated sintering activity. The sintering temperature and the pressure applied during sintering here determine whether a sintered article substantially retaining the pore structure or a compact sintered article is obtained.

The process according to the invention may particularly preferably also be used for the production of sintered articles from differing powders, for example of sintered metal articles from different metal powders or cermets, i.e. mixtures of metal and ceramic powders.

The agglomerates according to the invention are furthermore outstandingly well suited to the production of surface finishes, in particular if the agglomerates, once granulated, are applied at the sintering temperature under roller pressure onto the surface to be finished.

The subject matter of the invention was developed in connection with the development of tantalum powders for electrolytic capacitors.

The present invention accordingly in particular provides adhesively bound tantalum powder agglomerates having a pore volume of 80 to 90%. Tantalum powder agglomerates having a primary particle size (FSSS) of 0.3 to 0.6 μm are particularly preferred.

Powder granules produced from such agglomerates, moreover in accordance with the prior art, optionally by pre-sintering, are starting materials for tantalum electrolytic capacitors having an elevated specific charge and particularly low leakage current rate. The elevated specific charge and low leakage current rate of the capacitors are attributed to the particular sintering activity of the agglomerates during the initial heat treatment (pressureless sintering).

### EXAMPLE 1

A crude tantalum powder suitable for electrolytic capacitor production is used which consists of readily sintered primary particles of a size of 0.42 μm (FSSS). The bulk density of the powder is 11 g/inch³ (Scott method)=0.67 g/cm³.

A slurry of the powder is prepared in demineralised water and supernatant water is allowed to run off.

Drying is then performed at 70° C. under standard pressure, wherein the temperature is increased to 120° C. at the conclusion of drying. A porous cake having a density of 3.72 g/cm³ is obtained, which corresponds to a pore volume of 78%.

### EXAMPLE 2

Example 1 is repeated, wherein an aqueous solution containing 0.3% hydrogen peroxide is used instead of demineralised water. The resultant porous cake has a density of 2.96 g/cm³, which corresponds to a pore volume of 82.3%.

### EXAMPLE 3

### As Example 2. A 3% H₂O₂ solution is used.

The dry cake has a density of 2.5 g/cm³, which corresponds to a pore volume of 85%.

### EXAMPLE 4

A 5% H₂O₂ solution is used.

The dry cake has a density of 2.38 g/cm³, which corresponds to a pore volume of 86%.

### EXAMPLE 5

Water saturated with carbon dioxide at 1.5 bar is used.

The dry cake has a density of 2.41 g/cm³ and a pore volume of 85%.

### EXAMPLE 6

The dry cakes obtained from Examples 1 and 3 are treated as a block for 30 minutes at 105° C. under a high vacuum and screened to smaller than 200 μm.

The specimens, with addition of 2 wt. % of magnesium chips, are then deoxidised for 2 hours at 800° C. and washed with 5% sulfuric acid.

Deoxidation as described above is then repeated.

The specimen from Example 1 has a bulk density of 34 g/inch³, that from Example 3 of 27.5 g/inch³.

The specimens are then sintered for 10 minutes at 1250° C., at a press density of 5.0 g/cm³ to yield anodes and formed at a voltage of 16 V. Sintered density is 4.8 g/cm³ in both cases.

The specific capacitance and leakage current rate are 80058 μFV/g and 0.74 nA/μFV respectively in the case of the specimen from Example 1 and 87540 μFV/g and 0.63 nA/μFV respectively in the case of the specimen from Example 3.

1. Adhesively bound agglomerates of metallic and/or ceramic powders characterised by a pore volume of 80 to 90%.

2. Tantalum powder agglomerates characterised by a pore volume of 80 to 90%.

3. Process for the production of adhesively bound agglomerates of metallic and/or ceramic powders, wherein a slurry of the powders is prepared in water and the slurry dried to form an adhesively bound cake, characterised in that the slurry is prepared using water in which carbon dioxide or substances which, on drying, decompose to liberate gases, are dissolved.

4. Process according to claim 3, characterised in that the agglomerates are granulated by grinding and screening.

5. Process for the production of suspensions of finely divided powders, characterised in that agglomerates according to one of claims 3 or 4 are used.

6. Process for the production of porous sintered articles, characterised in that agglomerates according to one of claims 3 or 4 are used.
